(19) United States
(12) Patent Application Publication
(10) Pub. No.: US 2011/0146293 A1
(43) Pub. Date: Jun. 23, 2011

(54) METHOD FOR CONNECTING A STARTING MEANS TO A TURBOMACHINE

(75) Inventors: Samuel B. Shartzer, Greenville, SC (US); Jason D. Fuller, Simpsonville, SC (US); David A. Snider, Simpsonville, SC (US); Eugene A. Post, Glenville, NY (US)

(73) Assignee: General Electric Company

(21) Appl. No.: 12/646,164

(22) Filed: Dec. 23, 2009

(51) Int. Cl. F02C 7/26; F01K 13/02

(52) U.S. Cl. 60/778; 60/786; 60/646; 60/656

(57) ABSTRACT

An embodiment of the present invention provides a method of starting a powerplant machine, such as, but not limiting of, a turbomachine set to operate in a Fast Start mode. The turbomachine may include, but is not limited to, a steam turbine, a heavy-duty gas turbine, an aero-derivative gas turbine, and the like. An embodiment of the method of the present invention provides a new philosophy for controlling a starting system associated with the turbomachine. An embodiment of the present invention may be applied to a powerplant having multiple turbomachines and a starting system having multiple starting means, which may include at least one LCI system. Here, an embodiment of the present invention may eliminate the manual process of preparing and integrating a desired turbomachine with a desired starting means.

This application is related to commonly-assigned U.S. patent application Ser. No. 12/331,824 [GE Docket 230465-2], filed Dec. 10, 2008.

### BACKGROUND OF THE INVENTION

The present invention relates generally to the Fast Start operation of a powerplant machine, and more particularly, to a method of configuring a starting system to reduce the start-up time of the powerplant machine operating in a Fast Start mode.

“Fast Start” may be considered an operating mode requiring a powerplant machine to export a load capable of emissions complaint operation within a certain time after an operator initiates a start of that powerplant machine. Fluctuating energy demand is a major factor in determining when powerplant machines operate. Powerplant machines are commonly idled until sufficient demand requires operation. When demand requires operation, the powerplant machine performs a start-up process before exporting the requested energy (electricity, mechanical torque, steam, and the like).

Peaking or simple cycle plants execute fast starts and are then replaced by more efficient generation over a longer period. Moreover, the current assignee of the application, General Electric Company, has a portfolio of combined cycle (CC) power plants (CCPP), such as, but not limited to, those disclosed in US27113562A1, entitled “Method and Apparatus for Starting Up Combined Cycle Power Systems”. In addition, U.S. Pat. No. 4,207,864, entitled “Damper”; U.S. Pat. No. 4,208,882, entitled “Startup Attemperator”; U.S. Pat. No. 4,598,551, entitled “Apparatus and Method for Controlling Steam Turbine Operating Conditions During Starting and Loading”. Also, U.S. Pat. No. 5,361,585, entitled “Steam Turbine Split Forward Flow”; U.S. Pat. No. 5,412,936, entitled “Method of Effecting Start-up of a Cold Steam Turbine System in a Combined Cycle Plant”; U.S. Pat. No. 6,626,635, entitled “System for Controlling Clearance Between Blade Tips and a Surrounding Casing in Rotating Machinery”. Reference to these commonly assigned patents and patent applications can provide further insight into the scope of the present invention, and the Fast Start technology.

Each of the aforementioned technologies may require a starting system to start-up the powerplant components. A Load Commutated Inverter (LCI) is a type of starting system used in many powerplants. The LCI electrically converts a generator to a motor, which provides the mechanical torque needed to turn a rotor of the turbomachine, during the start-up process.

Currently, the LCI is not energized and is disconnected from the turbomachine until an operator initiates a start sequence. This process requires the operator to wait for the LCI to become energized and the associated components (switches, breakers, and the like) to move into the correct position. Additionally, on powerplant sites having multiple starting systems and multiple turbomachines, an operator manually selects a desired LCI to start a desired turbomachine.

Therefore, there is a desire for an improved method of starting a powerplant machine set to operate in a Fast Start mode. This system should be more efficient and reduce the start-up time in comparison to currently known systems.

### BRIEF DESCRIPTION OF THE INVENTION

In an embodiment of the present invention, a method of starting a powerplant machine in a Fast Start operating mode, the method comprising: providing a starting system configured for starting a powerplant machine; determining whether a Fast Start of the powerplant machine is desired; determining whether the starting system is ready for operating in a Fast Start mode; selecting a pre-connect mode of the starting system; determining whether a starting system operational sequence is complete; and determining whether the starting system is in the pre-connect mode; wherein the Fast Start mode prepares the starting system for operation before a request to start the powerplant machine is received, reducing an overall start-up time of the powerplant machine.

An alternate embodiment of the present invention provides a method of using a starting system to perform a Fast Start on at least one component of a powerplant, the method comprising: providing a powerplant, wherein the powerplant comprises multiple turbomachines and a starting system adapted for starting each of the turbomachines; providing an interconnection bus comprising a plurality of disconnects switches, wherein the interconnection bus electrically integrates one of the multiple turbomachines with the starting system; determining whether a Fast Start is desired; determining whether the starting system is prepared for a Fast Start mode of operation; selecting a pre-connect mode of the starting system; determining whether a starting system operational sequence finishes; wherein the starting system operational sequence electrically connects the starting system to the interconnection bus; and determining whether the starting system is in the pre-connect mode; wherein the Fast Start mode prepares the starting system for operation before a request to start the powerplant machine is received, reducing an overall start-up time of the powerplant machine.

Another alternate embodiment of the present invention provides a system configured for performing a Fast Start on at least one component of a powerplant, the system comprising: a powerplant, wherein the powerplant comprises multiple turbomachines and a starting system capable of starting each of the multiple turbomachines; an interconnection bus comprising a plurality of disconnects switches, wherein the interconnection bus electrically connects each of the multiple turbomachines to the starting system; and a control system configured for performing the steps of: determining whether a Fast Start is desired; determining whether the starting system is prepared for a Fast Start mode of operation; selecting a pre-connect mode of the starting system; determining whether a starting system operational sequence finishes; wherein the starting system operational sequence electrically connects the starting system to the interconnection bus; and determining whether the starting system is in the pre-connect mode; wherein the Fast Start mode prepares the starting system for operation before a request to start the desired turbomachine is received, reducing an overall start-up time of the turbomachine machine.

### BRIEF DESCRIPTION OF THE DRAWINGS

FIG. 1 is a schematic illustrating an environment within which an embodiment of the present invention may operate.

FIG. 2 is a block diagram illustrating a known method of using an LCI to start a turbomachine.

FIGS. 3A, 3B, collectively FIG. 3, are block diagrams illustrating a method of starting a turbomachine, in accordance with an embodiment of the present invention.

### DETAILED DESCRIPTION OF THE INVENTION

As discussed, “Fast Start” may be considered an operating mode of a powerplant machine. This mode generally requires the powerplant machine to export a load, while operating in emissions compliance, within a certain time after a start of that powerplant machine is initiated. As used herein, the term Fast Start is intended to include all such modes and equivalents thereof within the scope of this invention.

The present invention has the technical effect of reducing the start-up time associated with stating a powerplant machine. An embodiment of the present invention provides a method of starting a powerplant machine, such as, but not limiting of, a turbomachine set to operate in a Fast Start mode. The turbomachine may include, but is not limited to, a steam turbine, a heavy-duty gas turbine, an aero-derivative gas turbine, and the like. An embodiment of the method of the present invention provides a new philosophy for controlling a starting system associated with the turbomachine. An embodiment of the present invention may be applied to a powerplant having multiple turbomachines and a starting system having multiple starting means, which may include at least one LCI system. Here, an embodiment of the present invention may eliminate the manual process of preparing and integrating a desired turbomachine with a desired starting means.

Detailed example embodiments are disclosed herein. However, specific structural and functional details disclosed herein are merely representative for purposes of describing example embodiments: Example embodiments may, however, be embodied in many alternate forms, and should not be construed as limited to only the embodiments set forth herein.

Accordingly, while example embodiments are capable of various modifications and alternative forms, embodiments thereof are illustrated by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any, and all, combinations of one or more of the associated listed items.

The terminology used herein is for describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted might occur out of the order noted in the FIGS. For example, two successive FIGS. may be executed substantially concurrently or may sometimes be executed in the reverse order, depending upon the functionality/operations involved. Although embodiments of the present invention may be described in reference to a powerplant comprising multiple powerplant machines and a starting system comprising multiple starting machine, application of the present invention is not limited to the that type of powerplant configuration. Embodiments of the present invention may be applied to a system comprising one powerplant machine and one starting means. Embodiments of the present invention may be applied to a system comprising multiple powerplant machines and one starting means. Embodiments of the present invention may be applied to a system comprising one powerplant machine and multiple starting means.

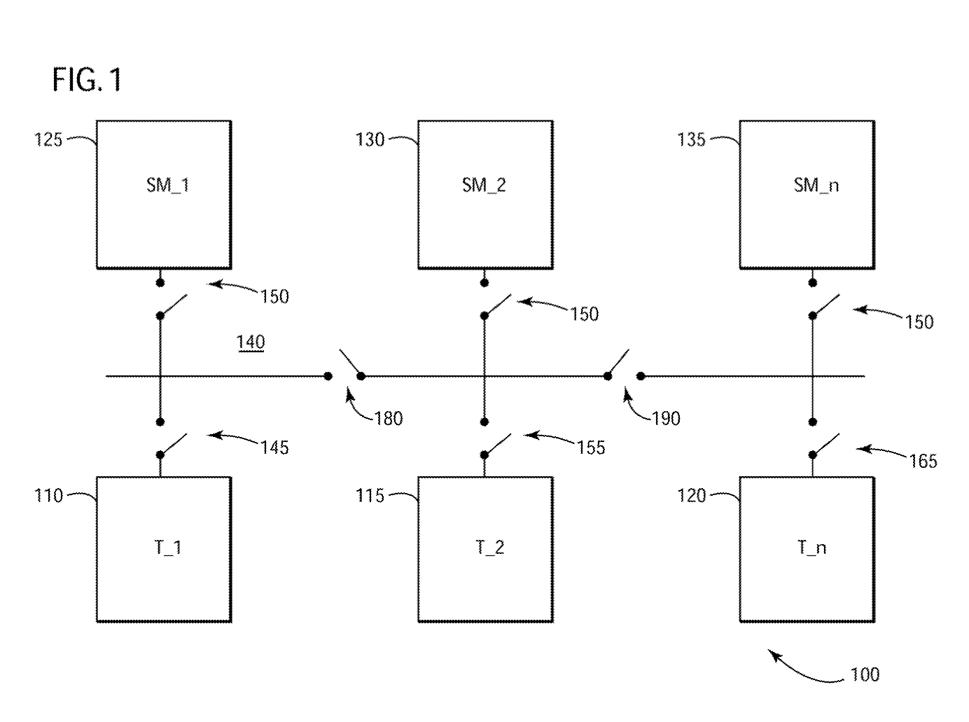

Referring now to the FIGS., where the various numbers represent like parts throughout the several views. FIG. 1 is a schematic illustrating an environment within which an embodiment of the present invention may operate. FIG. 1 illustrates a powerplant site 100 comprising multiple turbomachines 110, 115, and 120. Each of the turbomachines 110,115, and 120 may be electrically integrated with a starting system, which comprises starting means 125, 130, and 135. As discussed, at least one of the starting means may be an LCI system, or the like.

Prior to operation, an operator of the powerplant site 100 selects one of the turbomachines 110,115, and 120 and one of the starting means 125, 130, and 135. Next, the operator electrically connects the designated turbomachine 110,115, and 120 with the designated starting means 125, 130, and 135 via the interconnection bus 140. Here, various switch gear (some of which are not illustrated in the FIGS.), such as, but not limiting of, one of the turbomachine disconnect switches 145,155, and 165, one of the starting means disconnect switches 150, 160, and 170, and one of the tie switches 180, 190 are connected. The tie switches 180, 190 allow multiple turbomachines 110,115, and 120 and starting 125, 130, and 135 to simultaneously operate. This connection process allows for the designated starting means 125, 130, and 135 to drive the designated turbomachine 110,115, and 120 during the start-up operation. As known, this process is predominately a manual and time consuming process.

As will be appreciated, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit”, “module,” or “system”. Furthermore, the present invention may take the form of a computer program product on a computer-usable storage medium having computer-usable program code embodied in the medium. As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

Computer program code for carrying out operations of the present invention may be written in an object oriented programming language such as Java7, Smalltalk or C++, or the like. However, the computer program code for carrying out operations of the present invention may also be written in conventional procedural programming languages, such as the “C” programming language, or a similar language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a public purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram blocks.

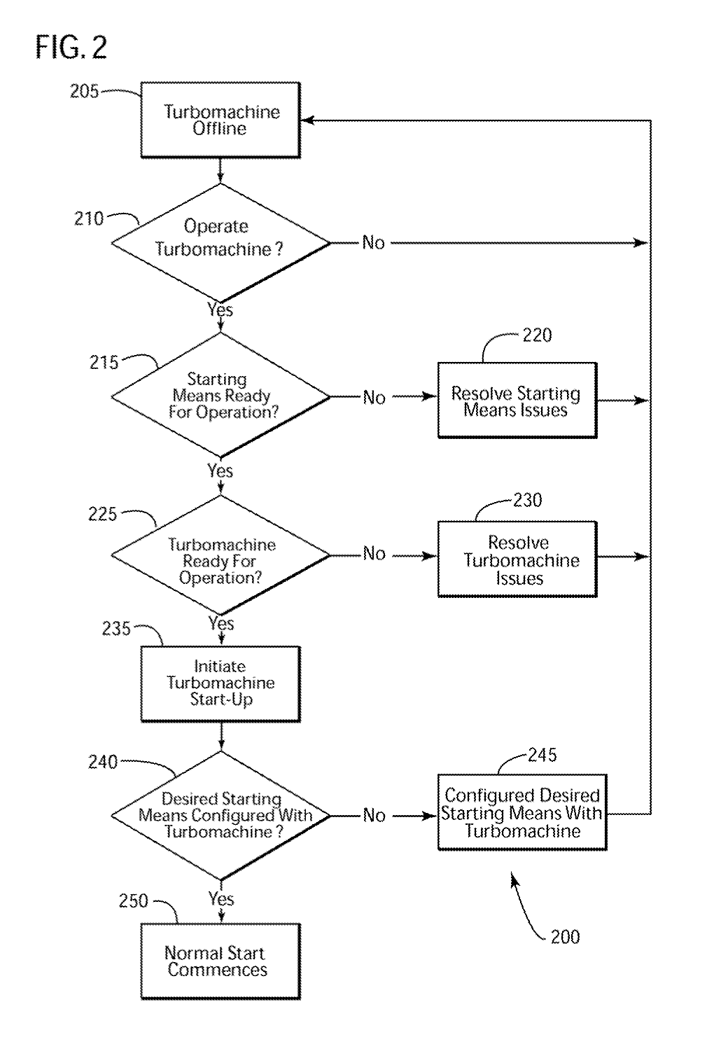

Referring again to the Figures, FIG. 2 is a block diagram illustrating a known method 200 of using a starting system comprising multiple LCIs to start a designated turbomachine. In step 205, the turbomachine is in an operating status requiring a start-up; such as, but not limiting of, on turning gear. Here, the operator of the turbomachine may be awaiting a request for power.

In step 210, the method 200 may determine whether to operate the turbomachine. Here, a request for energy may have been received. If the operator desires to start the turbomachine, then the method 200 may proceed to step 215; otherwise the method 200 may revert to step 205.

In step 215, the method 200 may determining whether the starting means is ready for operation. Here, for example, but not limiting of, an operator may determine whether the generator and the LCI, are ready for operation. If the starting means is ready for operation, then the method 200 may proceed to step 225; otherwise the method 200 may proceed to step 220.

In step 220, the method 200 may notify an operator of the issues with the starting means. The notification may be in the form of an alarm, notification, or image(s) on a graphical user interface (GUI), or other form of message; such as, but not limiting of, electronic, physical, audible, or combination thereof. After this step, the method 200 may revert to step 205.

In step 225, the method 200, may determine whether the turbomachine is ready for operation. Here the method 200 may be awaiting a signal, such as, but not limiting of, a “ready to start” indication. If the turbomachine is ready for operation, then the method 200 may proceed to step 235; otherwise the method 200 may proceed to step 230.

In step 230, the method 200 may notify an operator of the issues with the turbomachine. The notification may be in the form of an alarm, notification, or image(s) on a GUI, or other form of message; such as, but not limiting of, electronic, physical, audible, or combination thereof. After this step, the method 200 may revert to step 205.

In step 235, the method 200 may initiate a start of the turbomachine. Here, the operator may select “start” from a GUI integrated with the control system that controls the operation of the turbomachine.

In step 240, the method 200 may determine whether the operator has connected the designed LCI with the turbomachine. As discussed in relation to FIG. 1, this process may be a manual process where the operator has to configure the starting means, turbomachine, and integration bus (or the like). If the LCI and turbomachine are connected then the method 200 may proceed to step 250; otherwise the method 200 may proceed to step 245.

In step 245, the method 200 may notify the operator that the turbomachine may not start due to a configuration issue(s) with the designated LCI. The notification may be in the form of an alarm, notification, or image(s) on a GUI, or other form of message; such as, but not limiting of, electronic, physical, audible, or combination thereof. After this step, the method 200 may revert to step 205.

In step 250, the turbomachine may begin the normal start-up sequence. Here the LCI may apply torque to the rotor (s) of the turbomachine as required to execute the startup of the system.

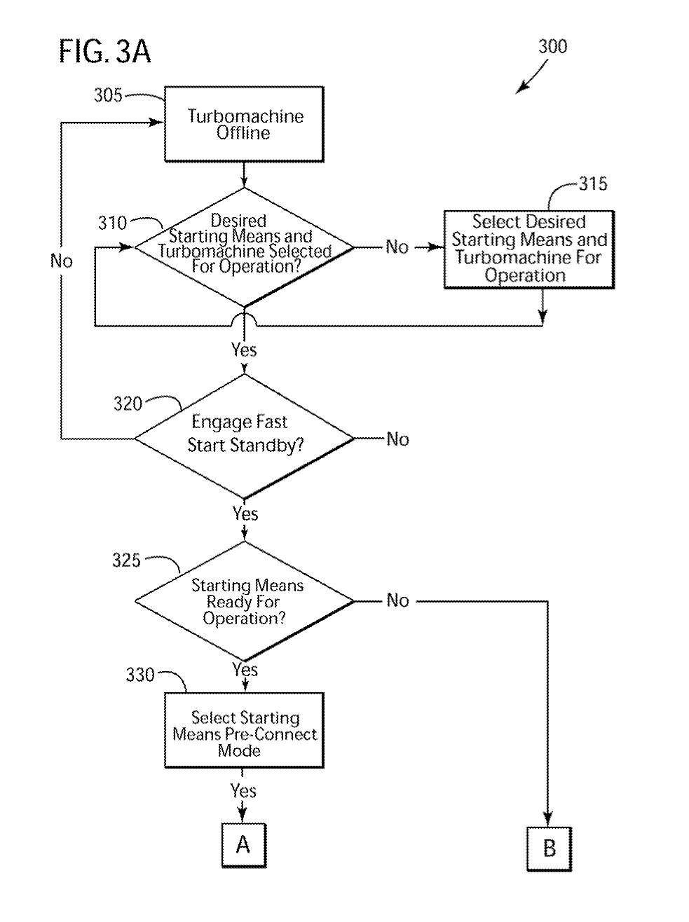

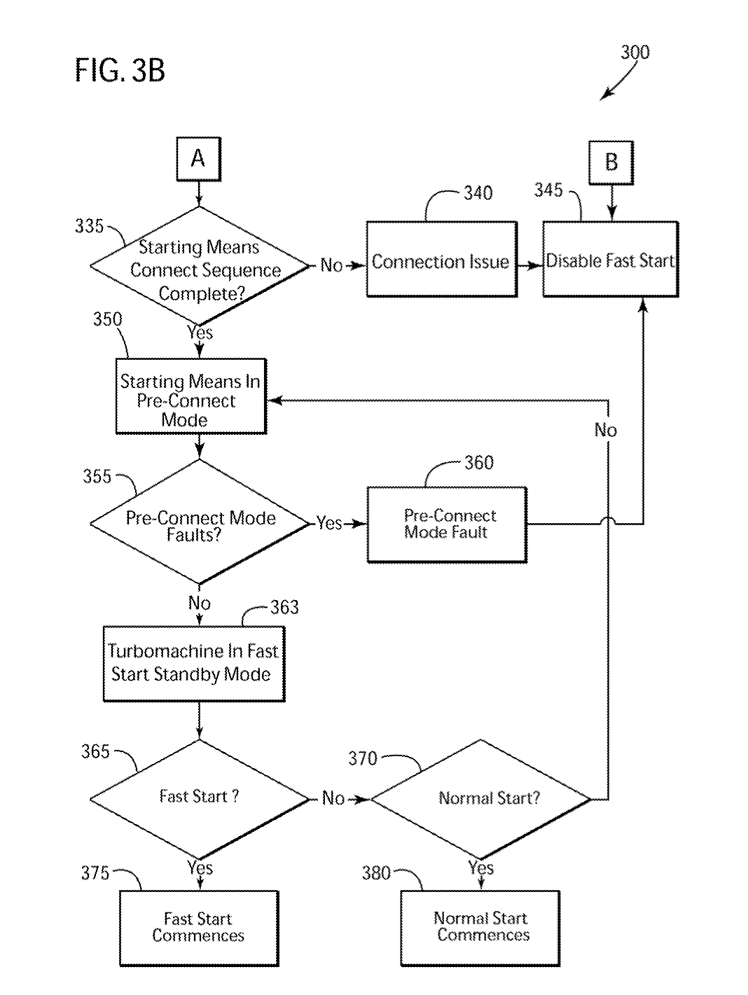

FIGS. 3A, 3B, collectively FIG. 3, are block diagrams illustrating a method 300 of starting a turbomachine, in accordance with an embodiment of the present invention. Essentially FIG. 3 is a block diagram illustrating a method 300 of using a starting system comprising multiple LCIs to start a designated turbomachine. However, as discussed, embodiments of the present invention may be applied to powerplant systems (or the like) comprising a variety of powerplant machines and starting systems.

In step 305, the turbomachine is in an operational status requiring a start-up; such as, but not limiting of, on turning gear. Here, the operator of the turbomachine may be awaiting a request for energy.

As discussed, embodiments of the present invention may reduce the steps or eliminate the manual steps of integrating a desired turbomachine with a desired starting means. Embodiments of the present invention may reduce the initialization time required by the starting means.

In step 310, the method 300 may determine whether a turbomachine and an LCI have been selected for operation. For example, but not limiting of, on a powerplant having a configuration similar to that of FIG. 1, the method 300 may determine whether an operator has selected a specific turbomachine and a specific starting means for operation. Here, an embodiment of the present invention may provide a GUI that may allow the operator to select which turbomachine and starting means are to be to operate. If a specific turbomachine and starting means have been selected then the method 300 may proceed to step 320; otherwise the method 300 may proceed to step 315.

In step 315, the method 300 may notify the operator that a selection of a turbomachine and a starting means is required. Here, the notification may be in the form of an alarm, notification, or image(s) on a GUI, or other form of message; such as, but not limiting of, electronic, physical, audible, or combination thereof. After this step, the method 300 may revert to step 310.

In step 320, the method 300 may determine whether the LCI should be configured for a Fast Start Standby mode. This configuration mode essentially pre-connects the LCI to the turbomachine; before a start of the turbomachine is initiated; unlike the known process described in FIG. 2. If the operator desires the LCI to enter the Fast Start Standby mode, then the method 300 may proceed to step 315; otherwise the method 300 may revert to step 305, or an operator may use the LCI in a manner similar to that described in FIG. 2.

In step 325, the method 300 may determine whether the starting means, such as, but not limiting of, an LCI, is ready for operation. Here, for example, but not limiting of, the LCI may perform checks to determine operational readiness. If the starting means is ready for operation then the method 300 may proceed to step 330, otherwise the method 300 may proceed to step 345.

In step 330, the starting means pre-connect mode may be selected. In an embodiment of the present invention, the method 300 may automatically selected this mode. In an alternate embodiment of the present invention, the method 300 may prompt the operator to select this mode. This alternate embodiment may be useful if a request for energy may be occur in the foreseeable future.

In step 335, the method 300 may determine whether the starting means has completed a connect sequence. This sequence may be considered the process that energizes the LCI by enabling and/or closing the associates disconnected switches, circuit breakers, and the like. This may allow the LCI to engage and synchronize the generator. If the connect sequence is complete then the method 300 may proceed to step 350; otherwise the method 300 may proceed to step 340.

In step 340, the method 300 may notify the operator of a connection issue preventing the connection sequence of step 335 from completing. Here, the notification may be in the form of an alarm, notification, or image(s) on a GUI, or other form of message; such as, but not limiting of, electronic, physical, audible, or combination thereof. After this step, the method 300 may proceed to step 345.

In step 345, the method 300 may disable the Fast Start configuration mode for the starting means, such as, but not limiting of, the LCI. As illustrated in FIG. 3, in an embodiment of the present invention, steps 325, 335, and 355 represent system tests occurring through the method 300. These tests generally serve to verify that the starting means in either configured and/or ready for operating in the Fast Start configuration mode. In an embodiment of the present invention the method 300 may notify the operator that the Fast Start configuration mode has been disabled. Here, the notification may be in the form of an alarm, notification, or image(s) on a GUI, or other form of message; such as, but not limiting of, electronic, physical, audible, or combination thereof. In another alternate embodiment of the present invention after step 345, the method 300 may revert to step 305.

In step 350, the starting means may considered to be in a pre-connect mode. This may considered an energized mode of the LCI. Here, the LCI is ready for connectivity to, and starting of, the turbomachine.

In step 355, the method 300 may determine whether at least one fault has occurred since the starting means entered the pre-connect mode. Here, the method 300 may continuously determine whether a fault has occurred. If a fault has not occurred, then the method 300 may proceed to step 365; otherwise the method 300 may proceed to step 360.

In step 360, the method 300 may notify the operator of the fault. Here, the notification may be in the form of an alarm, notification, or image(s) on a GUI, or other form of message; such as, but not limiting of, electronic, physical, audible, or combination thereof. Then, the method 300 may proceed to step 345, which was previously described.

In step 363 of the method 300, the turbomachine may be in a Fast Start Standby mode. Here, the method 300 may notify an operator of this current mode.

In step 365, the method 300 may determine whether an operator desires a Fast Start of the turbomachine. In an embodiment of the present invention, an operator may select a Fast Start icon, or the like, from the GUI. If a Fast Start is selected, then the method 300 may proceed to step 375; otherwise the method 300 may proceed to step 370.

In step 375, the method 300 may commence a Fast Start of the turbomachine. Here; the start means may expeditiously begin the start-up process shortly after the electrical connection and software permissives to the turbomachine is established via a disconnect switch, circuit breaker, Boolean logic communication, or the like; as described in relation to FIG. 1.

In step 370, the method 300 may determine whether an operator desires a Normal Start of the turbomachine. In an embodiment of the present invention, an operator may select a Normal Start icon, or the like, from the GUI. If a Normal Start is selected, then the method 300 may proceed to step 380; otherwise the method 300 may proceed to step 350 until there is a desire to start the turbomachine.

In step 380, may commence a Normal Start of the turbomachine. Here, the start means may begin the start-up process shortly after the electrical connection and the software permissives to the turbomachine is established via a disconnect switch; circuit breaker, Boolean logic communication, or the like; as described in relation to FIG. 1.

As discussed, embodiments of the present invention may substantially reduce the time required to connect, energize, and start a turbomachine. Furthermore, embodiments of the present invention may partially automate the process of selecting a turbomachine and a starting means on powerplant sites have multiples of the same.

As one of ordinary skill in the art will appreciate, the many varying features and configurations described above in relation to the several exemplary embodiments may be further selectively applied to form the other possible embodiments of the present invention. Those in the art will further understand that all possible iterations of the present invention are not provided or discussed in detail, even though all combinations and possible embodiments embraced by the several claims below or otherwise are intended to be part of the instant application. In addition, from the above description of several exemplary embodiments of the invention, those skilled in the art will perceive improvements, changes, and modifications. Such improvements, changes, and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

What is claimed is:

1. A method of starting a powerplant machine in a Fast Start operating mode, the method comprising:
providing a starting system configured for starting a powerplant machine;
determining whether a Fast Start of the powerplant machine is desired;
determining whether the starting system is ready for operating in a Fast Start mode;
selecting a pre-connect mode of the starting system;
determining whether a starting system operational sequence is complete; and
determining whether the starting system is in the pre-connect mode;
wherein the Fast Start mode prepares the starting system for operation before a request to start the powerplant machine is received, reducing an overall start-up time of the powerplant machine.

2. The method of claim 1, wherein the powerplant machine comprises at least one turbomachine.

3. The method of claim 1, wherein the starting system comprises multiple starting components, and wherein at least one of the multiple starting components comprises a Load Commutated Inverter (LCI).

4. The method of claim 1 further comprising the step of disabling the Fast Start mode if the starting system operational sequence is not complete.

5. The method of claim 4 further comprising determining whether at least one fault occurs after the step of the starting system enters the pre-connect mode.

6. The method of claim 5 further comprising the step of disabling the Fast Start mode if at least one fault occurs.

7. The method of claim 3, wherein the powerplant machine comprises multiple turbomachines.

8. The method of claim 7 further comprising the step of selecting a desired starting component and a desired turbomachine of the multiple turbomachines for a Fast Start operation.

9. The method of claim 8 further comprising the step of selecting a Fast Start operation of the desired turbomachine.

10. A method of using a starting system to perform a Fast Start on at least one component of a powerplant, the method comprising:
providing a powerplant, wherein the powerplant comprises multiple turbomachines and a starting system adapted for starting each of the turbomachines;
providing an interconnection bus comprising a plurality of disconnects switches, wherein the interconnection bus electrically integrates one of the multiple turbomachines with the starting system;
determining whether a Fast Start is desired;
determining whether the starting system is prepared for a Fast Start mode of operation;
selecting a pre-connect mode of the starting system;
determining whether a starting system operational sequence finishes; wherein the starting system operational sequence electrically connects the starting system to the interconnection bus; and
determining whether the starting system is in the pre-connect mode;
wherein the Fast Start mode prepares the starting system for operation before a request to start the powerplant machine is received, reducing an overall start-up time of the powerplant machine.

11. The method of claim 10, wherein the starting system comprises multiple starting components, and wherein at least one of the multiple starting components comprises a Load Commutated Inverter (LCI).

12. The method of claim 10 further comprising the step of disabling the Fast Start mode if the starting system operational sequence is in a fault state.

13. The method of claim 12 further comprising determining whether at least one fault occurs after the starting system enters the pre-connect mode.

14. The method of claim 13 further comprising the step of disabling the Fast Start mode if at least one fault occurs.

15. The method of claim 11 further comprising the step of selecting a desired starting components and a desired turbomachine for a Fast Start operation.

16. The method of claim 15 further comprising the step of selecting a Fast Start operation of the desired turbomachine.

17. A system configured for performing a Fast Start on at least one component of a powerplant, the system comprising:
a powerplant, wherein the powerplant comprises multiple turbomachines and a starting system capable of starting each of the multiple turbomachines;
an interconnection bus comprising a plurality of disconnects switches, wherein the interconnection bus electrically connects each of the multiple turbomachines to the starting system; and a
control system configured for performing the steps of:
a) determining whether a Fast Start is desired;
b) determining whether the starting system is prepared for a Fast Start mode of operation;
c) selecting a pre-connect mode of the starting system;
d) determining whether a starting system operational sequence finishes; wherein the starting system operational sequence electrically connects the starting system to the interconnection bus; and
e) determining whether the starting system is in the pre-connect mode;
wherein the Fast Start mode prepares the starting system for operation before a request to start the desired turbomachine is received, reducing an overall start-up time of the turbomachine machine.

18. The method of claim 17, wherein the starting system comprises multiple starting components, and wherein at least one of the multiple starting components comprises a Load Commutated Inverter (LCI).

19. The method of claim 10 further comprising the step of disabling the Fast Start mode if the starting system operational sequence experiences a fault.

20. The method of claim 12 further comprising determining whether at least one fault occurs after the starting system enters the pre-connect mode.
